(19) United States
(12) Patent Application Publication
(10) Pub. No.: US 2014/0154353 A1
(43) Pub. Date: Jun. 5, 2014

(54) NONLINEAR RHEOLOGY OF CHEWING GUM AND GUM BASE

(71) Applicants: Luca Martinetti, Minneapolis, MN (US); Christopher W. Macosko, Minneapolis, MN (US); Randy H. Ewoldt, St. Paul, MN (US); Lesile D. Morgret, Chicago, IL (US)

(72) Inventors: Luca Martinetti, Minneapolis, MN (US); Christopher W. Macosko, Minneapolis, MN (US); Randy H. Ewoldt, St. Paul, MN (US); Lesile D. Morgret, Chicago, IL (US)

(73) Assignee: WM. WRIGLEY JR. COMPANY, Chicago, IL (US)

(21) Appl. No.: 13/814,089

(22) PCT Filed: Aug. 5, 2011
(86) PCT No.: PCT/US2011/046819

§ 371 Date: Sep. 20, 2013

Related U.S. Application Data
(60) Provisional application No. 61/371,073, filed on Aug. 5, 2010.
(60) Provisional application No. 61/373,454, filed on Aug. 13, 2010.
(60) Provisional application No. 61/373,431, filed on Aug. 13, 2010.
(60) Provisional application No. 61/407,220, filed on Oct. 27, 2010.

(51) Int. Cl. A23G 4/18; G01N 3/08; G01N 3/24; A23G 4/08; G01N 3/00

(52) U.S. Cl. CPC A23G 4/18; A23G 4/08; G01N 3/00; G01N 3/24; G01N 3/08
USPC 426/3; 73/788; 73/841; 73/818

(57) ABSTRACT

A method of selecting a commercially viable chewing gum including testing a chewing gum using nonlinear rheology, compiling rheological data from the nonlinear rheology, and then comparing the rheological data obtained to rheological data ranges of commercially acceptable chewing gum. The nonlinear rheology can include large amplitude oscillatory shear test, start-up of steady uniaxial extension test, and uniaxial compression test (lubricated or unlubricated) and relaxation.

### PRIORITY DATA

The present patent application is a 371 of international application Ser. No. PCT/US11/46819 filed Aug. 5, 2011, which claims benefit from Ser. Nos. 61/371,073 filed Aug. 5, 2010; 61/373,431 filed Aug. 13, 2010; 61/373,454 filed Aug. 13, 2010; and 61/407,220 filed Oct. 27, 2010. All of the applications listed above are incorporated by reference as if entirely restated herein.

### BACKGROUND OF THE INVENTION

The present invention relates to rheological properties of chewing gum and gum base. More specifically, this invention relates to nonlinear rheology of chewing gum and gum base.

An important property of chewing gum and gum base is texture. Tests for measuring texture or correlating to texture may be divided into objective tests that are performed by instruments and sensory tests that are performed by people.

In early stages of the research and development of new chewing gum or gum base formulations, it may be too expensive or not feasible to do sensory testing with human subjects. Especially if the formulation includes new cutting edge ingredients that have not been food approved, there is a need to have an objective test that does not require humans to chew or consume the gum. Also for new ingredients, it may be very expensive to produce product in even small quantities so there is a need to be able to test new chewing gum or gum base formulations with as little material as possible. Also sensory tests can be expensive and may take a long time to set up and perform since it may require getting safety and toxicology studies beforehand as well as costs to run a sensory panel, pay panelists, and get analysis compiled. Therefore there is a need for an objective test that would be cheaper and be faster than performing sensory testing. Another need is to have comprehensive objective tests in the early stages so that subjective opinions are not the only screening methods for potential commercially viable chewing gum. Objective testing may allow for a bigger breadth of samples to be tested in the early stages of product development.

Objective tests for chewing gum and gum base include rheological, optical, chemical, and acoustical testing. Rheological testing of chewing gum including gum base in the linear viscoelastic region is known. A small amplitude oscillatory shear (SAOS) test may be performed to determine linear viscoelastic properties of materials including G′ (elastic or storage modulus), G″ (viscous or loss modulus), and tan delta (tangent of the phase angle—the ratio of viscous modulus to elastic modulus).

One problem with SAOS rheological testing in the linear viscoelastic region is that for materials like chewing gum and gum base that go through nonlinear large, complex, and unsteady deformations during chewing, processing, manufacturing, or even bubble forming, linear rheology does not sufficiently describe the deformations occurring in those situations.

There is a need for nonlinear rheology of chewing gum and gum base to determine commercial viability.

### SUMMARY OF THE INVENTION

A method of selecting a commercially viable chewing gum including testing a chewing gum using nonlinear rheology, compiling rheological data from the nonlinear rheology, and then comparing the rheological data obtained to rheological data ranges of commercially acceptable chewing gum. The nonlinear rheology can include large amplitude oscillatory shear (LAOS) test, start-up of steady uniaxial extension test, and lubricated or unlubricated uniaxial compression test.

### BRIEF DESCRIPTION OF THE DRAWINGS

FIG. 1 is a graph illustrating transient uniaxial extensional viscosity during start-up of steady uniaxial extension at constant Hencky strain rate and constant temperature.

FIG. 2 is a Pipkin diagram illustrating elastic and viscous Lissajous-Bowditch curves from a large amplitude oscillatory shear test at constant temperature.

FIG. 3a is a graph illustrating rheological data from an unlubricated uniaxial compression test at constant squeezing velocity and constant temperature.

FIG. 3b is a graph illustrating rheological data from a relaxation test at constant temperature after the unlubricated uniaxial compression test of FIG. 3a.

FIG. 4 illustrates an exemplary selection process that may be implemented in connection with the disclosure provided herein.

FIG. 5 illustrates the large rate tangent dynamic viscosity from a viscous Lissajous-Bowditch curve (stress versus strain-rate).

FIG. 6 is a graph illustrating rheological data from a large amplitude oscillatory shear test at constant temperature showing G′ and G″ versus strain for a 2 different commercial gums showing strain thinning.

FIG. 7 is a graph illustrating a comparison of transient uniaxial extensional viscosity of experimental chewing gums with L-I-L and I-L blends and commercial chewing gums.

FIG. 8 is a graph illustrating a comparison of transient uniaxial extensional viscosity of experimental chewing gums with L-M-L and 6M-L blends and commercial chewing gums.

### DESCRIPTION OF THE INVENTION

Chewing gum provides an excellent everyday example of viscoelastic behavior. It flows when being chewed or pulled slowly between the fingers, internal stresses persist after the deformation has ceased, and recoil occurs when it is suddenly relieved of an externally imposed stress. It also breaks when being blown into bubbles or pulled rapidly. Hence, understanding the rheological properties of chewing gums is important for application and processing purposes. The act of chewing involves nonlinear large, complex, and unsteady deformations from the closing phase, gliding phase, to the opening phase. The closing phase can be correlated to biaxial extension or uniaxial compression. The gliding phase can be correlated to large amplitude oscillatory shear test (LAOS) and the opening phase can be correlated to start up flows in uniaxial extension.

The present invention provides a method of selecting a commercially viable chewing gum using nonlinear rheology. The nonlinear rheology may include large amplitude oscillatory shear (LAOS), start-up of steady uniaxial extension, or relaxation after uniaxial compression (lubricated or unlubricated).

Selecting a commercially viable chewing gum includes testing a chewing gum using nonlinear rheology, compiling the rheological data from the nonlinear rheology, and then comparing the rheological data from the nonlinear rheology to rheological ranges of commercially acceptable chewing gum. Further, selecting a commercially viable chewing gum may include determining whether the rheological data from the nonlinear rheology falls within the rheological data ranges of commercial chewing gum.

Commercially acceptable chewing gum and gum base include chewing gums and gum bases that are already commercially available and have consumer accepted properties like texture and bubble formation. Commercial acceptable also means that the chewing gums and gum bases are manufacturable and processable for retail sale.

Whereas commercially viable may mean that the chewing gum and gum base has potential to be commercially acceptable and are within the realm of possibility that it may one day be commercially acceptable. Additionally, commercially viable may mean that the rheological properties of the chewing gum or gum base may not fall within the range of commercially acceptable products but lies close to the range. Closeness to the commercially acceptable rheological data range may mean that the new data taken be an order of magnitude or two orders of magnitude within the range.

Nonlinear rheology may include any methods or techniques to measure the nonlinear rheological properties of materials that flow.

In the nonlinear rheology described herein, may include controlling stress/force, strain, or strain rate, temperature or a combination of any of these parameters. Controlling these parameters may include keeping one of the parameters constant. For example, the strain may be kept constant during one of the tests described below. Control may also include changing one of the parameters in a step function. For example, the strain rate can be changed from zero to a constant rate or changed from a constant strain rate down to zero (to study the relaxation response of a material). Additionally, control may also include changing one of the parameters in an oscillatory function. In LAOS tests, the strain amplitude or the shear frequency may be varied in an oscillatory function.

Chewing gum samples are prepared for testing according to the method described below.

Sample Preparation for Start-Up of Steady Uniaxial Extension, LAOS, and Uniaxial Compression (Lubricated or Unlubricated) and Relaxation:

Approximately two to eight grams of chewing gum or gum base are chewed for at least 15 to 20 minutes. Alternatively, water soluble components may be extracted by placing a thin strip of chewing gum under running water overnight followed by kneading the gum by hand under running water for an additional two minutes. Yet another method is to knead the gum under running water for at least 20 minutes. Afterwards, samples of chewing gum or gum base are kept constantly in de-ionized water for at least 1 hour and no more than 12 hours to maintain hydration during measurements.

Testing Procedures for Start-Up of Steady Uniaxial Extension:

A ceramic tile is dabbed with tap water from a moist cloth to prevent sticking. The sample is placed on the ceramic tile fixed with a 0.7 mm spacer. Another ceramic tile, dabbed with tap water in the same manner, is placed on top of the cud and gentle pressure is applied until the second tile contacts the spacer. The sample is compressed for 30 to 60 seconds to maintain the thickness of 0.7 mm at room temperature. If necessary to prevent spring-back, the temperature of the tile and cud may be increased slightly by placing them in an oven. Such heating time and temperature should be limited to the minimum necessary to prevent spring-back. After compression, a 21 mm by 5 mm rectangular test specimen is cut from the flattened cud. Any remaining sample on the tile can be retained for further testing by covering the tile and flattened cud with a moist cloth to prevent drying. Samples are re-measured for more precise dimensions before loading onto the EVF fixture for the ARES.

Alternatively, a mold with rectangular holes with a press may be used at room temperature to form samples for start-up of steady uniaxial extension tests while keeping hydration. The pressed gum cud can be greater than or equal to 21 mm and the width and the thickness may vary in the range of 5-10 mm and 0.5-1 mm.

The rectangular sample is then loaded onto the uniaxial extensional viscosity fixture (EVF) on an TA Instruments ARES or ARES-G2 rotational rheometer. The sample is loaded by threading it carefully between the pins of the EVF fixture using wafer tweezers. The pins are then gently pressed into the sample specimen using the wafer tweezers using care not to press so far that the sample fails at the pin instead of in the deformation region (region between the rotating drums) during extension. Any portion of the cud not in the deformation region is lightly pressed onto the base of the drums to increase sample adhesion and thus prevent slipping during extension. After loading, the sample is equilibrated to 37° C. (mouth temperature) for 5 minutes before beginning the test (or other temperatures). Uniaxial extension measurements will be carried out up to sample failure (which typically occurs at Hencky strain ranging from 3 to 10).

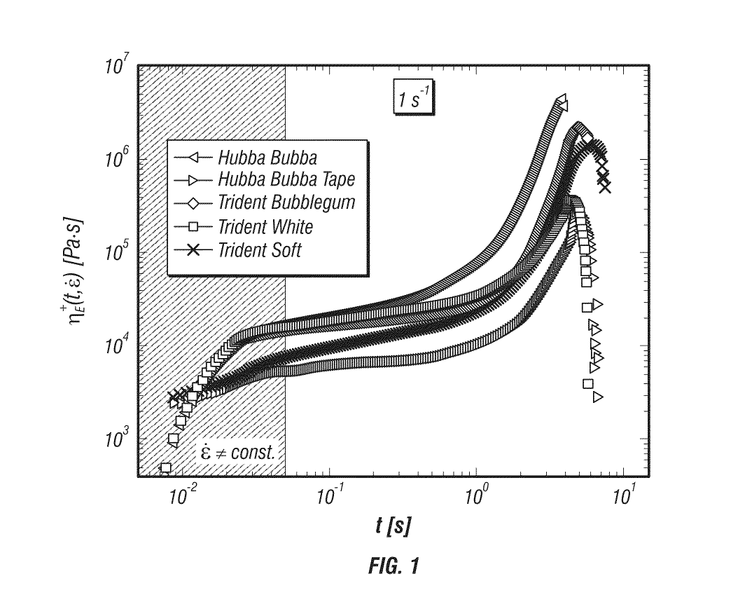

Uniaxial extensional strain hardening parameter is measured by plotting uniaxial extensional viscosity on a log plot versus a log plot of time. A representative log plot of uniaxial extensional viscosity (Pa*s) versus log plot of time at 37° C. is shown in FIG. 1. The start-up of steady uniaxial extension test for FIG. 1 was conducted with the following samples:

A sample of a commercial chewing gum, US Trident White® Chewing Gum manufactured by Cadbury, was purchased from a retail market.

A sample of a commercial chewing gum, US Trident Soft Chewing Gum manufactured by Cadbury, was purchased from a retail market.

A sample of a commercial chewing gum, US Trident® Bubble Gum manufactured by Cadbury, was purchased from a retail market.

A sample of a commercial chewing gum, US Hubba Bubba® Outrageous Original manufactured by Wm. Wrigley Jr. Company, Chicago, Ill. USA was purchased from a retail market.

A sample of a commercial chewing gum, US Hubba Bubba® Tape Outrageous Original manufactured by Wm. Wrigley Jr. Company, Chicago, Ill. USA was purchased from a retail market.

As can be seen in FIG. 1, the two bubble gums (US Trident Bubble Gum and US Hubba Bubba Outrageous) show greater strain hardening parameter than chewing gum. As bubbles form, there are areas of localized thinning (defects in the bubble). Without strain hardening, the thinning/defects would propagate and make the bubble fail. If you have greater strain hardening, the gum will resist deformation better and share the stress (from the defect) with the surrounding areas. Start-up of steady uniaxial extension testing is effective in determining bubble forming capabilities of the gum and therefore a useful tool in determining commercially viable gums.

Testing Procedures for LAOS:

TA Instruments ARES-G2 Rheometer may be used with a cone and plate configuration, specifically, an 8 mm cone with a recirculating fluid bath. The sample that has been hydrated in de-ionized water is then stamped out of the bulk chewed gum with a metal stamper. Then the outside of the sample is dried with a paper towel. The sample is then loaded onto the lower rheometer plate and compressed to a trim gap and trimmed with a scapel. For chewing gum, the trim gap is 0.07 mm. For bubble gum, the trim gap is 0.075 mm. The sample is then compressed to the cone geometry gap and then allowed to equilibrate for 5 minutes and heated by the recirculating fluid bath to 37° C. (mouth temperature) or other temperatures. The transient LAOS test includes 5 delay cycles and 5 sampling cycles with strain sweep from 0.01-1000% at 3 points per decade and 256 data points collected per cycle using frequencies 0.1, 1 and 10 rad/s.

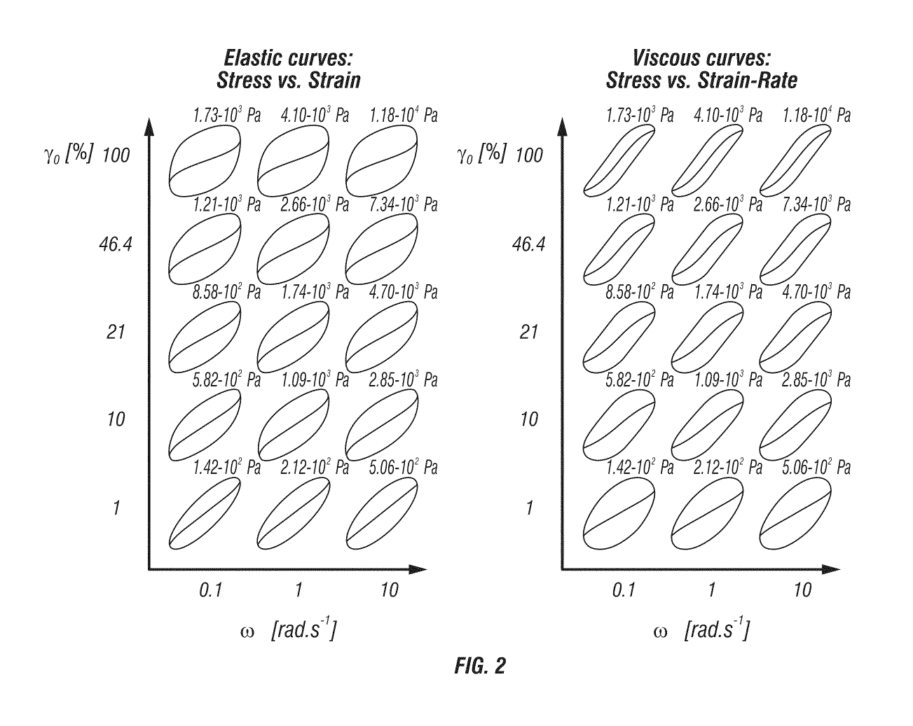

An example of data output from LAOS testing at 37° C. is shown in FIG. 2. FIG. 2. shows Pipkin diagrams for US Eclipse® Peppermint Chewing Gum manufactured by Wm. Wrigley Jr. Company, Chicago, Ill. USA, which was purchased from a retail market. FIG. 2. shows an example of ranges for strain amplitude, γ₀, and frequency, ω. As shown in FIG. 2, the strain amplitude can range from 0.01 to 210% and the frequency can range from 0.1 to 10 rad-s⁻¹.

Testing Procedures for Uniaxial Compression (Lubricated or Unlubricated):

TA Instruments ARES-G2 Rheometer may be used with parallel plates with a convection oven or parallel plates with the bottom plate being heated. Bulk chewed gum is pressed through a Teflon mold with 8 mm diameter and 6 mm height. Excess gum is trimmed from the mold and the sample is pressed out of mold and remolded to a cylinder shape. The sample is then loaded between lubricated parallel plates (with silicon oil) or unlubricated and compressed to initial test gap L₀=6 mm. The sample is allowed to equilibrate for 5 min at 37° C. in the convection oven or other temperatures. The sample is then compressed at a constant Hencky strain rate.

Testing Procedure for Uniaxial Compression and Relaxation:

TA Instruments ARES-G2 Rheometer may be used with parallel plates. Both plates may be made of steel or a plate that is made of cement and another made of steel. Bulk chewed gum is prepared and loaded between the parallel plates. The plates may be lubricated or unlubricated. The sample is then allowed to equilibrate for 5 min at 37° C. or other temperatures via a convention over or other heating means. The sample is then compressed to a final gap value at a constant speed. Next, the sample is then held at the final gap value and relaxed for a period of time.

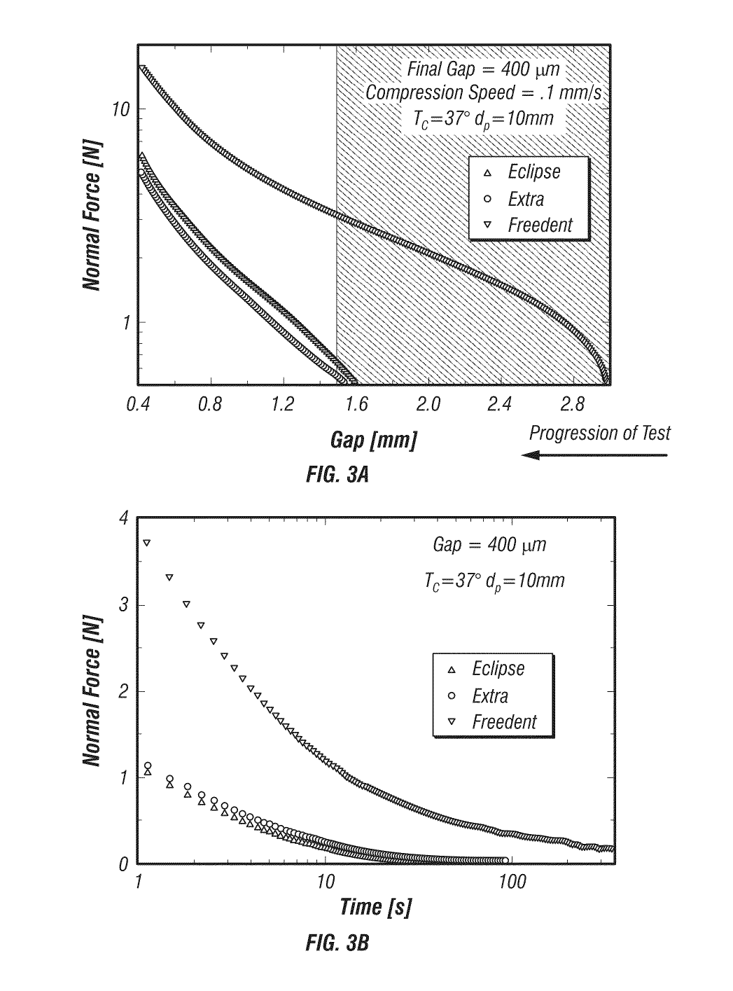

FIG. 3a is an example of data output for an unlubricated uniaxial compression test conducted at 37° C. at a constant uniaxial compression speed of 0.1 mm/s to a final gap of 4 mm for US Eclipse® Peppermint Chewing Gum, US Extra® Peppermint Chewing Gum, and US Freedent® all manufactured by Wm. Wrigley Jr. Company, Ill. USA, which was purchased from a retail market. The top parallel plate is made of cement and the lower plate is made of steel. The samples have a diameter of 10 mm. FIG. 3a is a plot of the gap length in mm versus the normal force in Newtons as the samples are compressed.

FIG. 3b is an example of data output for a relaxation test following the unlubricated uniaxial compression test conducted from FIG. 3a. The chewing gum samples are kept at a gap of 4 mm at 37° C. and the normal force (Newtons) is measured versus time. Typically chewing involves uniaxial compression rates between 1 s⁻¹ and 10 s⁻¹ and therefore, biaxial extension or uniaxial compression rheological data are good indicators of determining commercial viability or selecting commercially viable chewing gum and gum base.

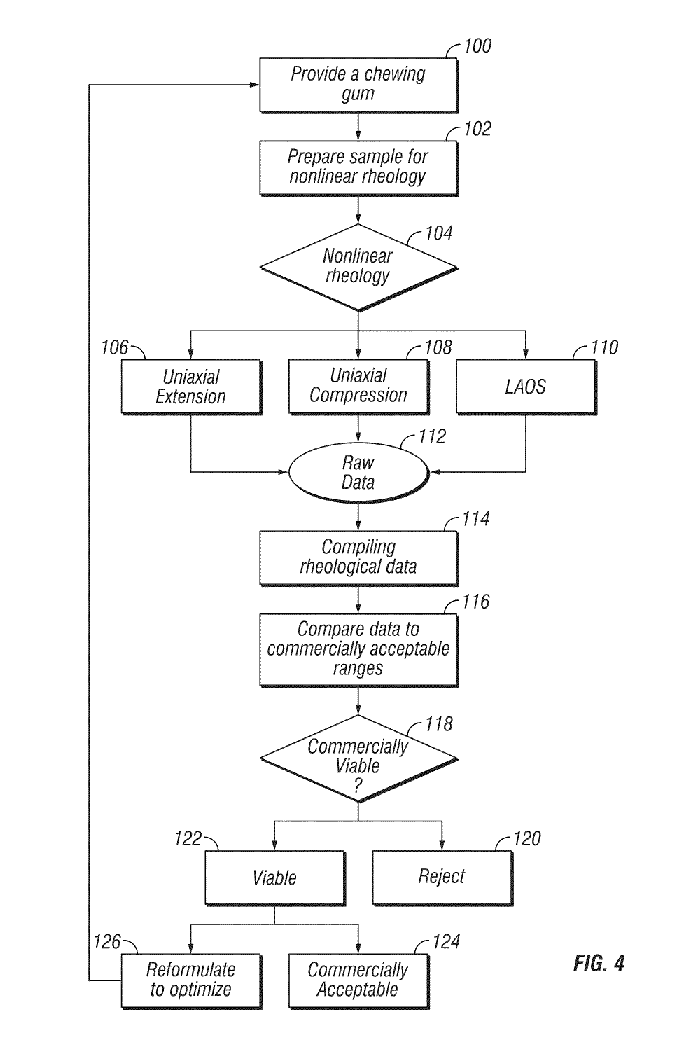

FIG. 4 is an exemplary selection process for selecting a commercially viable chewing gum. In the flow chart in FIG. 4, rectangular boxes represent individual steps, and diamond shape box represents a decision point. The arrows represent a sequential flow of steps. At step 100, a chewing gum is provided. The chewing gum may be a new formulation or an old formulation. At step 102, the chewing gum is prepared as a sample for the nonlinear rheology. The sample may be prepared by methods described above or with any other known methods of preparation for nonlinear rheology. At step 104, there is a decision point in deciding a particular nonlinear rheology. At step 106, start-up of steady uniaxial extension can be measured using the method described above. At step 108, uniaxial compression test can be performed using the method described above. Another alternative is shown at step 110, in which LAOS test can be performed using the method described above. At step 112, raw data is generated from the nonlinear rheology. At step 114, the raw rheological data is then compiled. Additionally, there can be another data processing step after the compilation of data which can be performed by software like MITLaos (available through Massachusetts Institute of Technology). At step 116, a comparison between the nonlinear rheological data from step 114 to rheological data ranges of commercially acceptable chewing gum. The ranges for commercially acceptable chewing gum and gum base can be calculated by test several commercial gums. The comparison can then be made to see if the gum being tested is commercially viable compared to commercially acceptable chewing gum. After step 116, there is a decision point at step 118 in determining whether the chewing gum sample is commercially viable. If the nonlinear rheological data for the sample chewing gum is so far from being commercially viable, the formulation may be rejected at step 120. Otherwise, the sample chewing gum may be commercially viable at step 122. The sample chewing gum may be commercially acceptable without needed further work at step 124. Otherwise, if there is potential or promise that the sample gum formulation is commercially viable then it may be reformulated or optimized to get closer nonlinear rheological data to commercial gums at step 126. In which case, the reformulated gum may go back to step 100.

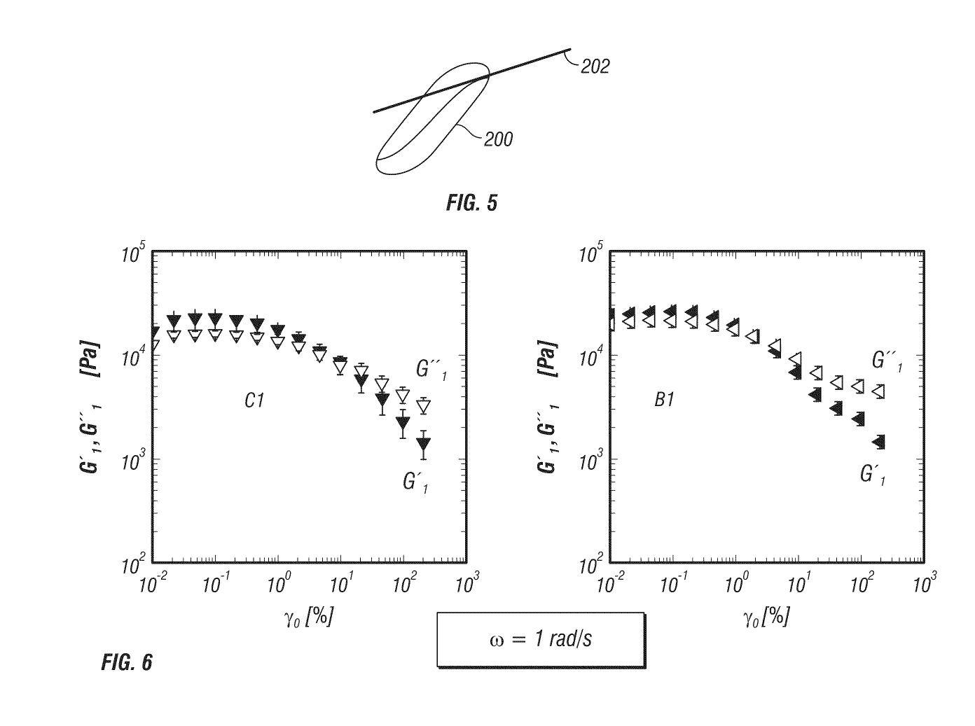

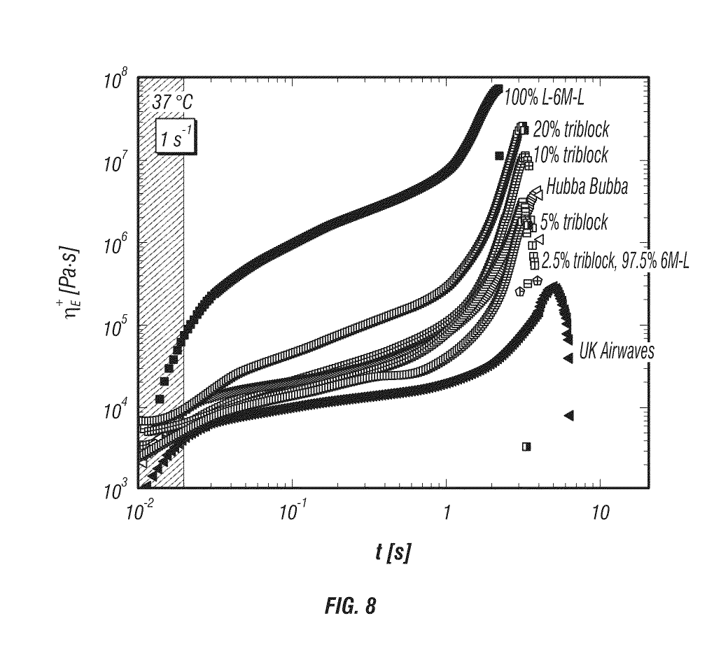

Rheological data ranges of commercially acceptable chewing gums may be different depending on the nonlinear rheology used. For start-up of steady uniaxial extension tests, the stress plateau value at Hencky strain less than 1, the Hencky strain at the break of a sample, and the maximum stress/plateau stress are important parameters. Commercially acceptable chewing gums may typically have a stress plateau value (at strain less than 1) between 3,000 to 300,000 Pa, and preferably from 6,000 to 30,000 Pa. Another rheological parameter for commercially acceptable chewing gums is the Hencky strain at the break point. The Hencky strain at break for commercially acceptable chewing gums is from 1 to 12 and preferably from 3.5 to 9.6. The value of the maximum stress divided by the plateau stress is another important parameter. Commercially acceptable chewing gums have a maximum stress/plateau stress between 1 to 100, and preferably between 30 to 100. In FIG. 8, the curve for the UK Airwaves sample has a stress plateau 306, Hencky strain at break 203, and maximum stress 304. For LAOS tests, the large rate tangent dynamic viscosity (η′_{K}) and the behavior of the G′ and G″ vs. strain are important rheological parameters for commercially acceptable gums. First, the large rate tangent dynamic viscosity (η′_{K}) is illustrated by FIG. 5. On a viscous curve 200, the large rate tangent dynamic viscosity 202 is measured. Typically values of (η′_{K}) at strain (γ₀) equals 1, and frequency (ω) at 10 rad/s, for commercially acceptable chewing gums are between 20 to 4,000 Pa·s, and preferably from 200 to 1,000 Pa·s. Additionally, the behavior of a curve of the G′ and G″ vs. strain for an strain sweep using LAOS is important. Commercially acceptable chewing gums exhibit sheer thinning which means that G′ and G″ decrease as a function of the strain amplitude. By way of example, FIG. 6 shows strain thinning for a sample C1, US Eclipse Peppermint Chewing Gum manufactured by Wm. Wrigley Jr. Company, Chicago, Ill. USA (purchased from a retail market) at a frequency of 1 rad/s and for another commercial gum, sample B1, US Hubba Bubba Outrageous Original manufactured by Wm. Wrigley Jr. Company, Chicago, Ill. USA, purchased from a retail market.

For uniaxial compression tests followed by a relaxation test, the maximum uniaxial compression force at a final gap value and the normal force after 20 second of relaxation are important rheological parameters. First, the maximum uniaxial compression force at a constant speed of 0.1 mm/s to a final gap of 0.4 mm, and plate diameter of 10 mm, is between 5 to 20 N for commercially acceptable chewing gums. The normal force after 20 seconds of relaxation for commercially acceptable chewing gums is between 0 to 2 N, and preferably between 0.1 to 1.5 N.

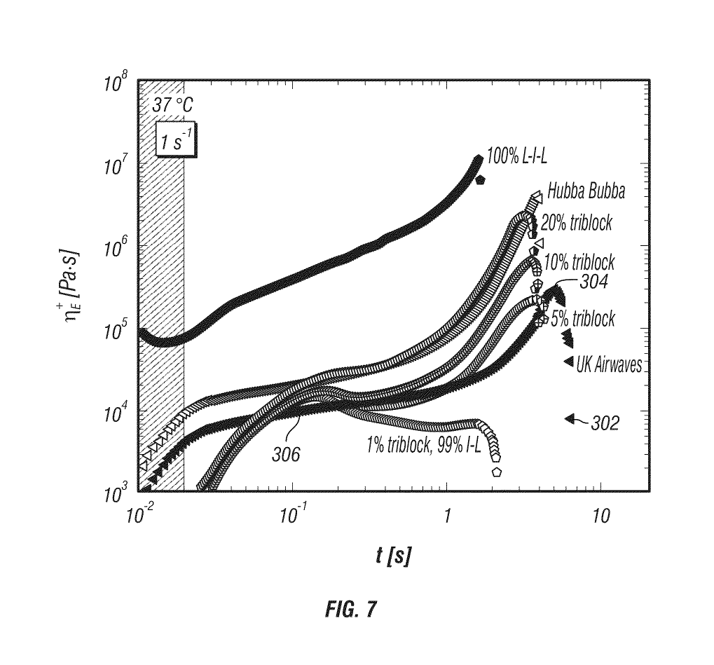

FIG. 7 is an example of plot comparing commercially acceptable gums (Hubba Bubba and UK Airwaves) to experimental chewing gums (with gum base materials of L-I-L at 100%, 20% L-I-L and 80% I-L, 10% L-I-L and 90% I-L, 5% L-I-L and 95% I-L, 1% L-I-L and 99% I-L). These experimental gums have a polymer system with a triblock (L-I-L) and diblock (I-L) blends as described in a patent application WO2011/032026 filed Sep. 10, 2010. Chewing gum samples of the commercial and experimental gums are each prepared according to the methods described in this application for a start-up of steady uniaxial extension test. The raw data is collected for each of the samples and then compiled on the plot of FIG. 7. The experimental chewing gums are compared against the commercial chewing gum curves. According to FIG. 7, the experimental samples of 20% L-I-L and 80% I-L, 10% L-I-L and 90% I-L, and 5% L-I-L and 95% I-L are commercially viable because they are within the rheological data ranges for commercially acceptable gum. These 3 experimental gums could then be further optimized by changing a number of ingredients or processing means. The plot of FIG. 7 could be used to determine what modifiers (softeners, plastic resins, or others) could be added to improve performance from a rheological perspective. Additionally, the plot of FIG. 7 helps to determine the ratio of triblock to diblock polymer that would be within a commercially acceptable range. Further, sensory tests may be performed on these experimental gums to determine what other characteristics needs to be developed in order to make these experimental gums in to commercial gums. FIG. 8 is another example of a plot comparing commercially acceptable gums (Hubba Bubba and UK Airwaves) to experimental chewing gums (with gum base materials of L-M-L at 100%, 20% L-M-L and 80% 6M-L, 10% L-M-L and 90% 6M-L, 5% L-M-L and 95% 6M-L, 2.5% L-M-L and 97.5% 6M-L). These experimental gums have a polymer system with a triblock (L-M-L) and diblock (6M-L) blends as described in a patent application WO2011/032026 filed Sep. 10, 2010. Similar to the plot of FIG. 7, the plot of FIG. 8 can be used to determine the commercially viable chewing gums with different ratios of polymer blends.

Reformulation or optimization may include changing a gum base in the chewing gum. Changing a gum base may include changing the physical structure of a polymer in the gum base by crosslinking the polymer, increasing or decreasing the molecular weight of the polymer, branching the polymer, making the polymer more linear, or by changing the chemical structure of the polymer by changing the constituent monomers. Additionally, reformulating or optimizing the chewing gum may include adding a different gum base, increasing or decreasing by weight of a softener, filler, emulsifier, and/or a plasticizer in the chewing gum or even changing those ingredients to another softener, filler, emulsifier, or plasticizer.

The fundamental components or ingredients of a chewing gum typically are a water-insoluble gum base portion and a generally water-soluble bulk portion. The primary component of the gum base is an elastomeric polymer which provides the characteristic chewy texture of the product. The gum base will typically include other ingredients which modify the chewing properties or aid in processing the product. These include plasticizers, softeners, fillers, emulsifiers, plastic resins, as well as colorants and antioxidants. The generally water soluble portion of the chewing gum typically includes a bulking agent together with minor amounts of secondary components such as flavors, high-intensity sweeteners, colorants, water-soluble softeners, gum emulsifiers, acidulants and sensates. Typically, the water-soluble bulk portion, sensates, and flavors dissipate during chewing and the gum base is retained in the mouth throughout the chew. Even though they are often water insoluble, flavors and sensates are at least partially released with the water soluble bulking agent during chewing and are considered part of the water soluble portion.

A water-insoluble gum base typically constitutes approximately 5 to about 95 percent, by weight, of a chewing gum of this invention; more commonly, the gum base comprises 10 to about 50 percent of a chewing gum of this invention; and in some preferred embodiments, 20 to about 35 percent, by weight, of such a chewing gum.

In addition to the water-insoluble gum base portion, a typical chewing gum composition includes a water-soluble bulk portion (or bulking agent) and one or more flavoring agents. The water-soluble portion can include high intensity sweeteners, binders, flavoring agents (which may be water insoluble), water-soluble softeners, gum emulsifiers, colorants, acidulants, fillers, antioxidants, and other components that provide desired attributes.

The present invention may be used with a variety of processes for manufacturing chewing gum including batch mixing, continuous mixing, sheeting, extrusion, coating, and tableted gum processes.

Chewing gum is generally manufactured by sequentially adding the various chewing gum ingredients to commercially available mixers known in the art. After the ingredients have been thoroughly mixed, the chewing gum mass is discharged from the mixer and shaped into the desired form, such as by rolling into sheets and cutting into sticks, tabs or pellets or by extruding and cutting into chunks. The product may also be filled (for example with a liquid syrup or a powder) and/or coated for example with a hard sugar or polyol coating using known methods.

After forming, and optionally filling and/or coating, the product will typically be packaged in appropriate packaging materials. The purpose of the packaging is to keep the product clean, protect it from environmental elements such as oxygen, moisture and light and to facilitate branding and retail marketing of the product.

1.-32. (canceled)

33. A method of selecting a commercially viable chewing gum comprising:
a) testing a chewing gum using nonlinear rheology;
b) compiling rheological data from the nonlinear rheology; and
c) comparing the rheological data from the nonlinear rheology to rheological data ranges of commercially acceptable chewing gum.

34. The method of claim 33, wherein the nonlinear rheology includes large amplitude oscillatory shear test.

35. The method of claim 33, wherein the nonlinear rheology includes measuring startup of steady uniaxial extension.

36. The method of claim 33, wherein the nonlinear rheology includes measuring uniaxial compression.

37. The method of claim 33, further comprising determining whether the rheological data from the nonlinear rheology falls within the rheological data ranges of commercial chewing gum.

38. The method of claim 37, further comprising reformulating the chewing gum to optimize the rheological data from the nonlinear rheology.

39. The method of claim 38, wherein the reformulation of the chewing gum is selected from the group consisting of changing a gum base in the chewing gum, adding a different gum base, and combinations thereof.

40. The method of claim 39, wherein changing the gum base includes increasing or decreasing the molecular weight of a polymer in the gum base.

41. The method of claim 39, wherein changing the gum base includes crosslinking a polymer in the gum base.

42. The method of claim 39, wherein reformulating the chewing gum includes increasing or decreasing the amount by weight of a chewing gum ingredient selected from the group consisting of a softener, a filler, an emulsifier, and a plasticizer or combinations thereof.

43. The method of claim 34, wherein the large amplitude oscillatory shear test includes increasing strain amplitude, γ₀, at a constant frequency, ω.

44. The method of claim 34, wherein the large amplitude oscillatory shear test includes increasing characteristic flow time, (γ₀ω)⁻¹, at a constant strain amplitude, γ₀.

45. The method of claim 34, wherein the large amplitude oscillatory shear test includes varying strain amplitude, γ₀, and frequency, ω, simultaneously so that the product of the strain amplitude and frequency remains the same.

46. The method of claim 34, wherein the rheological data range of commercially acceptable chewing gum based on a large rate tangent dynamic viscosity (η′_{K}) is between 20 to 4,000 Pa·s.

47. The method of claim 34, wherein the rheological data range of commercially acceptable chewing gum based on large rate tangent dynamic viscosity (η′_{K}) is between 200 to 1,000 Pa·s.

48. The method of claim 34, wherein the rheological data range of commercially acceptable chewing gum based on a G′ and G″ vs. strain curve show a decrease in both G′ and G″ as a function of strain amplitude, γ₀.

49. The method of claim 35, further comprising applying a constant Hencky strain rate, ε, to the chewing gum.

50. The method of claim 35, wherein the rheological data range of commercially acceptable chewing gum based a stress plateau at stress less than 1 is between 3,000 to 300,000 Pa.

51. The method of claim 35, wherein the rheological data range of commercially acceptable chewing gum based on stress plateau at stress less than 1 is between 6,000 to 30,000 Pa.

52. The method of claim 35, wherein the rheological data range of commercially acceptable chewing gum based on a Hencky strain at break is between 1 to 12.

53. The method of claim 35, wherein the rheological data range of commercially acceptable chewing gum based on the Hencky strain at break is between 3.5 to 9.5.

54. The method of claim 35, wherein the rheological data range of commercially acceptable chewing gum based on maximum stress divided by plateau stress is between 1 to 100.

55. The method of claim 35, wherein the rheological data range of commercially acceptable chewing gum based on maximum stress divided by plateau stress is between 30 to 99.

56. The method of claim 36, further comprising axially compressing the chewing gum at a constant velocity.

57. The method of claim 56, further comprising applying a constant normal force to the chewing gum.

58. The method of claim 36, wherein the rheological data range of commercially acceptable chewing gum based on a maximum uniaxial compression force at a speed of 0.1 mm/s to a final gap of 0.4 mm with a plate diameter of 10 mm is between 5 to 20 Newtons.

59. The method of claim 36, wherein the rheological data range of commercially acceptable chewing gum based on a force after 20 seconds of relaxation is between 0.1 to 2 Newtons.

60. A method of selecting a commercially viable chewing gum comprising:
a) measuring rheological properties of a chewing gum product in a nonlinear viscoelastic region;
b) comparing such measured nonlinear rheological properties of the gum with nonlinear rheological properties of known commercially acceptable chewing gum product; and
c) determine a commercially viable chewing gum product based on such comparison.

61. The method of claim 60, wherein measurement of the rheological properties of a chewing gum product in a nonlinear viscoelastic region includes tests selected from the group consisting of large amplitude oscillatory test, uniaxial extension flow test, uniaxial compression test, and combinations thereof.
